(19) United States
(12) Patent Application Publication
(10) Pub. No.: US 2012/0037439 A1
(43) Pub. Date: Feb. 16, 2012

(54) THERMAL CONTROL OF A HYBRID POWER TRAIN USING SHAPE MEMORY ALLOYS

(76) Inventors: Vivek Anand Sujan, Columbus, IN (US); J. Stephen Wills, Columbus, IN (US)

(21) Appl. No.: 12/855,310

(22) Filed: Aug. 12, 2010

(51) Int. Cl. B60K 11/00; F28F 27/00

(52) U.S. Cl. 180/68.1; 165/96; 903/907

(57) ABSTRACT

A system includes a vehicle having a hybrid power train. The hybrid power train has a battery pack with a number of cells. The system further includes a heat transfer device including a shape memory alloy (SMA). The SMA in a low temperature position provides a first heat transfer environment to the battery pack, and in a high temperature position provides a second heat transfer environment to the battery pack. The first heat transfer environment provides a first heat transfer amount to the battery pack, and the second heat transfer environment provides a second heat transfer amount to the battery pack. The second heat transfer amount is greater than the first heat transfer amount.

### BACKGROUND

The technical field generally relates to power systems having multiple power input sources, in particular including a power source that is electrically driven and has an electric power storage device. Systems having multiple power sources have different power sources and sinks distributed around the physical platform. The devices have varying thermal environments, requirements, and efficient operating points. Flexibility in controlling the thermal environment and response for one or more components of the hybrid power train improves the overall operating performance of the hybrid power train. Further, it may be desirable that certain devices have varying heat transfer environments at varying operating points, for example having a decreased heat transfer environment during a warm-up event and an increased heat transfer environment during normal operations. Therefore, further technological developments are desirable in this area.

### SUMMARY

One embodiment is a unique apparatus for thermal control of a hybrid power train with a shape memory alloy (SMA). Other embodiments include unique methods, systems, and apparatus for providing a first heat transfer environment to an electrical power device at a low temperature, and a second heat transfer environment to the electrical power device at a higher temperature. Further embodiments, forms, objects, features, advantages, aspects, and benefits shall become apparent from the following description and drawings.

### BRIEF DESCRIPTION OF THE DRAWINGS

FIG. 1 is a schematic diagram of a system for thermal control of a hybrid power train using a shape memory alloy (SMA).

FIG. 2A is a schematic diagram of an apparatus for thermal control of a hybrid power train, including an SMA comprising vents in a first heat transfer position.

FIG. 2B is a schematic diagram of an apparatus for thermal control of a hybrid power train, including an SMA comprising vents in a second heat transfer position.

FIG. 3A is a schematic diagram of an apparatus for thermal control of a hybrid power train, including an SMA comprising fins in a first heat transfer position.

FIG. 3B is a schematic diagram of an apparatus for thermal control of a hybrid power train, including an SMA comprising fins in a second heat transfer position.

FIG. 4A is a schematic diagram of an apparatus for thermal control of a hybrid power train, including an SMA comprising a coolant valve in a first heat transfer position.

FIG. 4B is a schematic diagram of an apparatus for thermal control of a hybrid power train, including an SMA comprising a coolant valve in a second heat transfer position.

FIG. 5A is a schematic diagram of an apparatus for thermal control of a hybrid power train, including an SMA operably coupled to a coolant valve in a first heat transfer position.

FIG. 5B is a schematic diagram of an apparatus for thermal control of a hybrid power train, including an SMA operably coupled to a coolant valve in a second heat transfer position.

FIG. 6A is a schematic diagram of an apparatus for thermal control of a hybrid power train, including an SMA engageably coupled to cells of a battery pack in a first heat transfer position.

FIG. 6B is a schematic diagram of an apparatus for thermal control of a hybrid power train, including an SMA engageably coupled to cells of a battery pack in a second heat transfer position.

FIG. 7A is a schematic diagram of an apparatus for thermal control of a hybrid power train, including an SMA comprising fins coupled to a heat sink, in a first heat transfer position.

FIG. 7B is a schematic diagram of an apparatus for thermal control of a hybrid power train, including an SMA comprising fins coupled to a heat sink in a second heat transfer position.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

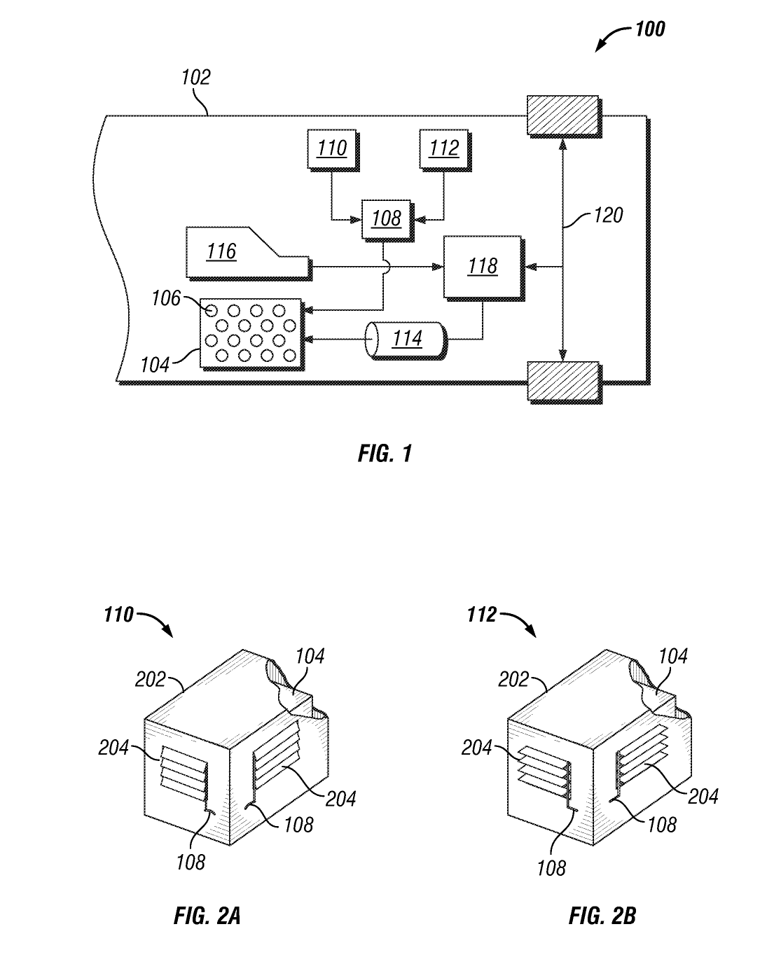

Referencing FIG. 1, a system for thermal control of a hybrid power train using a shape memory alloy (SMA) is illustrated. The SMA provides variable heat transfer environments to electrical power devices of the hybrid power train. An SMA transitions from a first shape to a second shape when the temperature of the SMA goes above a transition temperature. The SMA may be a “one-way” or “two-way” SMA. Where the SMA is a “one-way” SMA, a biasing force may be applied against the SMA such that at low temperature the position of the SMA is the desired position, and at high temperature the SMA works against the biasing force to move to the correct high temperature position. Where the SMA is a “two-way” SMA, the SMA may provide the movement without the need for a biasing force, although a biasing force may nevertheless be used. The biasing force may be a spring, a weight of an object applied against the SMA, or any other biasing force understood in the art.

Each SMA described herein may be a one-way or two-way SMA, and specific implementation of a one-way versus a two-way will not be provided to enhance the clarity of description.

A variety of SMAs are known in the art, and any SMA known in the art that transitions in the relevant temperature ranges for the electronic components and coolant streams herein are contemplated. For example, Nitinol is a well known SMA having transition temperatures in the relevant range for many electronic components and coolant streams therefore. The specific temperatures (e.g. desired operating temperature of a battery pack) that are desirable are dependent upon the hardware and control mechanisms utilized for particular embodiments. These specific temperature ranges that are desirable for electronic components and coolant streams are well known to those of skill in the art contemplating a specific system, and are not described specifically herein.

Generally, higher temperatures increase a battery capacity while reducing the battery life. Battery operating ranges that are desirable depend upon the application, the balance of battery capacity versus battery life that is desired, and the availability of and installation expense committed to battery cooling. Battery operating ranges from −20° C. to 100° C. are not unusual, with desirable ranges typically being warm and less than 60° C., although higher desirable ranges are possible. As is known in the art, some materials (e.g. Ni—Cd batteries) will generally be operated at lower desirable temperatures. For other electronic components, such as motor-generators, the thermal ratings of insulation, magnets, and the internal resistance curve with temperature will define desirable temperature ranges.

The system 100 includes a vehicle 102 having a hybrid power train. The hybrid power train includes at least two power sources, one of which is an electrical power source. The system 100 includes an internal combustion engine 116 as one of the power sources, and a battery pack 104 having a number of cells 106 as a portion of the electrical power source. The electrical power source includes an electric motor/generator 114.

The system 100 includes an electric motor/generator 114 schematically as a single device coupled to the battery pack 104, but as known in the art the motor and generator portions of the motor/generator 114 may be separate devices, and further power electronics (not shown) may be provided between the motor, generator, battery, and/or the power converter 118. The power electronics include rectifiers, transformers, and/or other devices to adjust any aspect of the flowing electrical power (e.g. voltage, frequency, current, and/or AC versus DC operation) as known in the art. The system 100 is illustrated as a series-parallel configuration, with either the electrical side or the combustion side capable of powering the driveline 120 to move the vehicle 102 and allowing the engine 116 to charge the battery pack 104 through the motor/generator 114. However, the hybrid power train may be parallel, series, series-parallel, or any other arrangement allowing multiple sources to provide motive power to the driveline 120.

The system 100 further includes a heat transfer adjustment device 108 having a shape memory alloy (SMA). The SMA in a low temperature position provides a first heat transfer environment 110 thermally coupled to the battery pack 104, and in a high temperature position provides a second heat transfer environment 112 thermally coupled to the battery pack 104. The first heat transfer environment 110 provides a first heat transfer amount with the battery pack 104 and the second heat transfer environment 112 provides a second heat transfer amount with the battery pack 104. The second heat transfer amount is greater than the first heat transfer amount.

For example, referencing FIGS. 2A and 2B, the first heat transfer environment 110 includes the vents 204, on a housing 202 containing the battery pack 104, partially closed or closed, and the second heat transfer environment 112 includes the vents 204 open or more fully open than with the first heat transfer environment 110. The first heat transfer environment 110 includes the vents 204 in a low flow rate position, and the second heat transfer environment 112 includes the vents 204 in a high flow rate position. The temperature at which the SMA 108 transitions shapes may be selected at any temperature known in the art according to the desired operating temperature of the battery pack 104 and the available materials for the SMA 108. Specific examples include a temperature at which the battery pack 104 is “warmed up”, for example at an efficient operating temperature, or a temperature at which the battery pack 104 is close to exceeding a high temperature at which the battery pack 104 is no longer operating efficiently.

In certain embodiments, the vents 204 may be on the device (e.g. the battery pack 104) rather than on a housing 202 containing the device. The device may be any electronic component in the hybrid power train, including at least the motor/generator 114, any motor or any generator in the system, an ultra capacitor (not shown), and/or the power electronics (not shown). The examples in FIGS. 2A and 2B include the SMA 108 coupled to the vents 204 to move the vents 204 in response to a shape change of the SMA 108. Alternatively or additionally, the vents 204 may be made of the SMA 108 such that the vents 204 raise or lower in response to the shape change of the SMA 108.

In certain embodiments, the second heat transfer amount is greater than the first heat transfer amount relative to the same operating condition of the system 100. For example, referencing FIG. 4, the first heat transfer environment 110 is a low coolant flow rate 408 through a device 404 in thermal contact with the battery pack 104, and the second heat transfer environment 112 is a high coolant flow rate 410 through the device in thermal contact with the battery pack 104. The second heat transfer amount is greater than the first heat transfer amount at the same operating condition of the system (e.g. at a fixed coolant temperature). However, the first heat transfer amount at certain operating conditions may be greater than the second heat transfer amount at differing operating conditions (e.g. the first heat transfer amount at a low coolant temperature may be greater than the second heat transfer amount at a high coolant temperature). In alternate or additional embodiments, the heat transfer amounts are coefficients of heat transfer rather than aggregate heat transfer amounts.

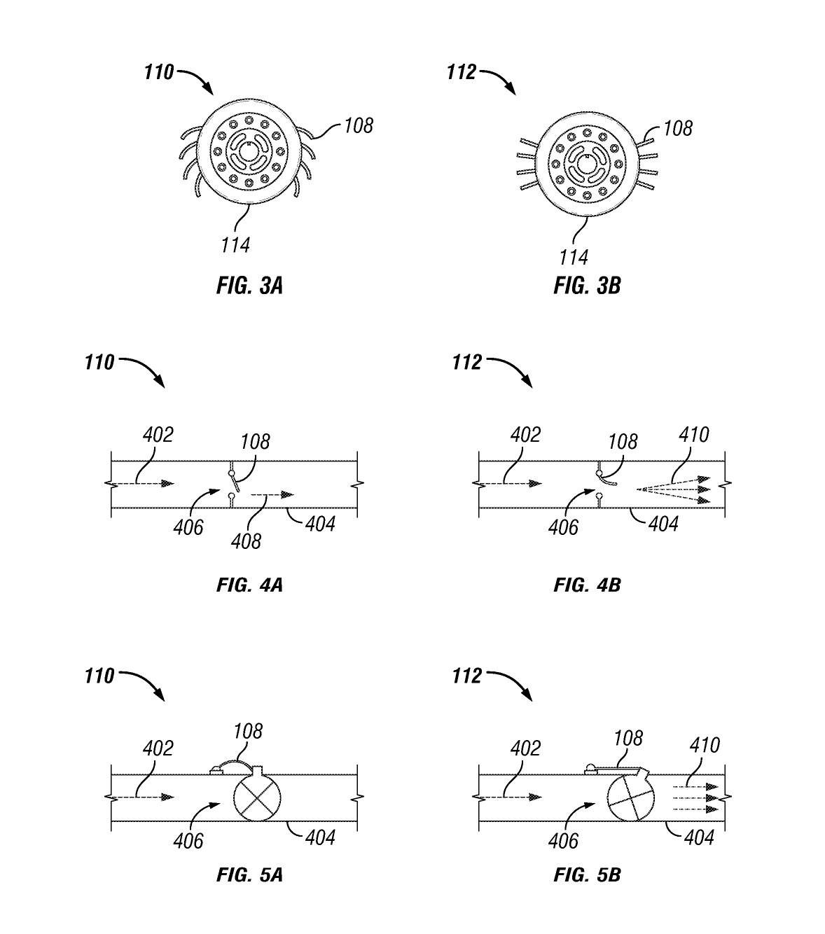

Referencing FIG. 3A, an SMA 108 positions fins in a first heat transfer position to provide a first heat transfer environment 110 coupled to the motor/generator 114. Referencing FIG. 3B, the SMA 108 positions fins in a second heat transfer position to provide a second heat transfer environment 112 coupled to the motor/generator 114. In the examples of FIGS. 3A and 3B, the fins are made of the SMA 108. Alternatively, the fins can be mechanically coupled to the SMA 108 to move appropriately at the in response to the SMA 108 shape transition, or the fins may be formed partially from the SMA 108. The device thermally attached to the fins is shown to be the motor/generator, but the device may be any other electronic device in the hybrid power train including at least the battery pack 104, a housing 202 for an electronic component, an ultra capacitor, and/or the power electronics.

The first heat transfer environment 110 includes the fins in a low heat transfer position. The low heat transfer position includes the fins lowered, raised, or at a position relatively toward the electronic device the fins are cooling. The second heat transfer environment 112 includes the fins in a high heat transfer position. The high heat transfer position includes the fins raised, lowered, or positioned relatively away from the electronic device the fins are cooling.

Referencing FIG. 4A, the SMA 108 includes a control valve 406, where the SMA 108 in a first position provides a first heat transfer environment 110. Referencing FIG. 4B, the SMA 108 is a second position provides the second heat transfer environment 112. The flowing coolant 402 in the device 404 is in thermal contact with an electrical power device, for example the battery pack 104. The first heat transfer environment 110 includes the SMA 108 in a closed or low-flow position within the coolant valve 406, and the second heat transfer environment 112 includes the SMA 108 in an open or high-flow position within the coolant valve 406. The flowing coolant 402 in the device 404 may be in thermal contact with any electrical power device within the hybrid power train. The SMA 108 in FIGS. 4A and 4B responds to the temperature of the flowing coolant 402, allowing the coolant to flow at a high rate when the temperature increases to the shape transition temperature of the SMA 108 and at a lower rate when the coolant decreases below the shape transition temperature of the SMA 108.

Referencing FIG. 5A, the SMA 108 is operably coupled to a control valve 406 in a first heat transfer position that provides a first heat transfer environment 110 thermally coupled to an electrical power device. The first heat transfer environment 110 is a low flow and/or a closed position of the valve 406 to provide a low flow rate of the coolant 402 in the device 404, or to provide stagnant coolant in thermal contact with the electrical power device. In certain embodiments, the valve 406 may include a bypass or hole that provides a low flow rate of the coolant 402 even when the valve 406 is closed. The flowing coolant, e.g. coolant 410 in FIG. 5B, is in thermal contact with a cooled electronic component of the hybrid power train, for example a cooling jacket of the battery pack 104. The SMA 108 in FIG. 5B is in a second position providing a second heat transfer environment 112 thermally coupled to the electrical power device. The second heat transfer environment 112 is a high flow position of the valve 406 to provide a flow and/or a high rate flow of the coolant 410 through the valve 406.

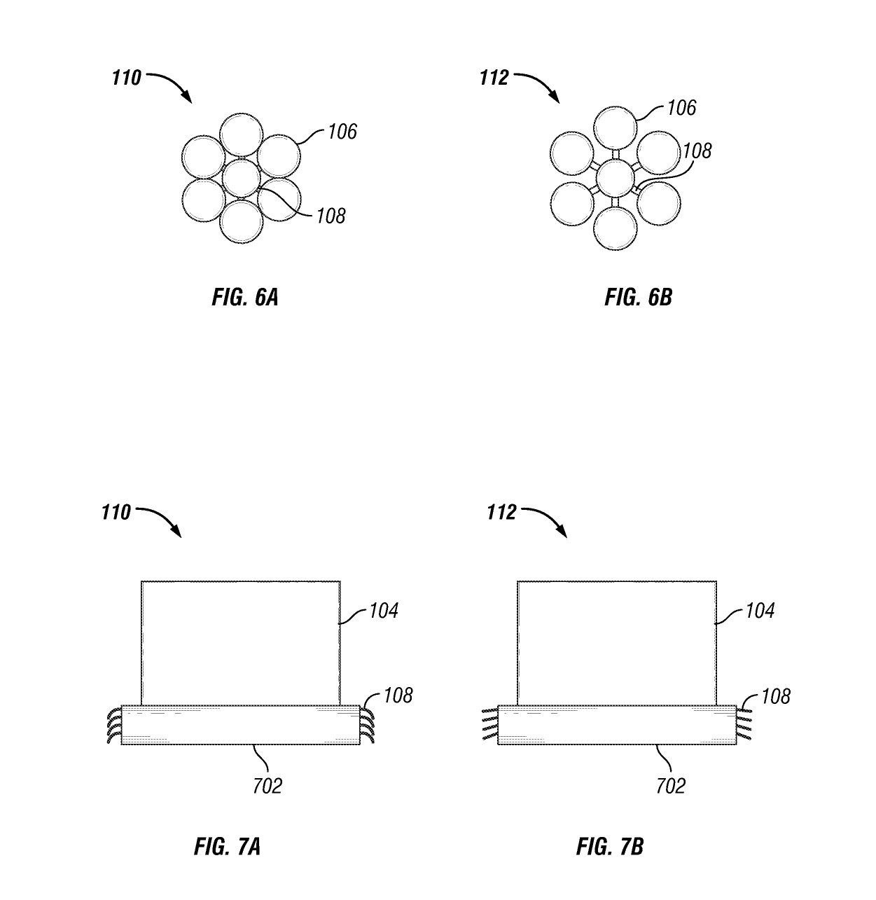

Referencing FIG. 6A, the SMA 108 engageably couples cells 106 of a battery pack 104 such that, in a low temperature conformation the cells 106 are positioned in close proximity and in a higher temperature conformation the cells 106 are positioned further apart. Thereby, the SMA 108 provides a first heat transfer environment 110 thermally coupled to the battery pack 104 in a first position (FIG. 6A) and provides a second heat transfer environment 112 thermally coupled to the battery pack 104 in a second position (FIG. 6B). The first heat transfer environment 110 includes a low heat transfer spacing, and the second heat transfer environment 112 includes a high heat transfer spacing.

Referencing FIG. 7A, the SMA 108 includes fins thermally coupled to a heat sink 702, which is thermally coupled to the battery pack 104. The example of FIGS. 7A and 7B is similar to the example of FIGS. 3A and 3B, with the fins coupled directly to a heat sink 702 rather than the electrical power device being cooled. FIG. 7A illustrates the SMA 108 in a low temperature position providing a first heat transfer environment 110 thermally coupled to the battery pack 104, and FIG. 7B illustrates the SMA 108 in a high temperature position providing the second heat transfer environment 112 thermally coupled to the battery pack 104. The first heat transfer environment 110 includes the fins moved toward the heat sink 702 or a housing 202 of the electrical power device, and the second heat transfer environment 112 includes the fins moved away from the heat sink 702 or the housing 202. The heat sink 702 may be thermally coupled to any electrical power device of the hybrid power train.

Another exemplary embodiment is a system including a vehicle having a hybrid power train, where the hybrid power train includes an electrical power device. The system further includes a means for selecting a heat transfer environment of the electrical power device between a first heat transfer environment and a second heat transfer environment. Non-limiting examples of a means for selecting the heat transfer environment of the electrical power device are described.

An exemplary means for selecting the heat transfer environment of the electrical power device includes an SMA mechanically coupled to a vent. The vent is moved toward a closed position when the SMA is in a low temperature position and the vent is moved toward an open position when the SMA is in a high temperature position. The vents are on a housing of the electrical power device, on the electrical power device, and/or are positioned between a space surrounding the electrical power device and a heat sink area including the ambient environment or other space where heat from the electrical power device is vented. In further examples, the SMA includes the vent or a portion of the vent.

Another exemplary means for selecting the heat transfer environment of the electrical power device includes the SMA including fins such that, in a low temperature position the fins provide for reduced heat transfer between the electrical power device and the surroundings, and in a high temperature position the fins provide for increased heat transfer between the electrical power device and the surrounding. The SMA may be mechanically coupled to the fins, and/or may include the fins or a portion of the fins. The fins provide the heat transfer changes by being attached to the electrical power device, attached to a housing of the electrical power device, by being a part of the electrical power device or the housing, and/or by being attached to or a part a heat sink thermally coupled to the electrical power device.

Another exemplary means for selecting the heat transfer environment of the electrical power device includes the SMA including a coolant flow valve or a portion of a coolant flow valve, and/or the SMA being operationally coupled to the coolant flow valve. In a low temperature position, the SMA provides a low flow through the valve by moving the valve to a low flow position, or by providing the low flow position directly within the valve (e.g. by acting as a gate or flapper within the valve). In a high temperature position, the SMA provides a high flow through the valve by moving the valve to a high flow position, or by providing the high flow position directly within the valve. The low flow position is any amount of flow less than the high flow position, including the valve being closed. The closed valve may allow some flow through a bypass or hole through a portion of the valve, or the closed valve may stop coolant flow entirely. The high flow position is any amount of flow greater than the low flow position, including the valve being open, and/or the valve being fully open.

The electrical power device in the hybrid power train includes the battery pack, cells within the battery pack, any electric motor and/or generator, power electronics, and/or an ultra-capacitor. In certain embodiments, the means for selecting the heat transfer environment of the electrical power device operates without any electrical power to perform the selection.

As is evident from the figures and text presented above, a variety of embodiments according to the present invention are contemplated.

An exemplary embodiment is an apparatus, including a hybrid power train having an electrical power device. The apparatus further includes a heat transfer adjustment device comprising a shape memory alloy (SMA). The SMA in a low temperature position provides a first heat transfer environment for the electrical power device and in a high temperature position provides a second heat transfer environment for the electrical power device.

An exemplary SMA is structured to move vents, wherein for the first heat transfer environment the vents are in a low flow rate position and wherein for the second heat transfer environment the vents are in a high flow rate position. An exemplary low flow rate position includes the vents being closed, and an exemplary high flow rate position includes the vents being open.

Another exemplary SMA is structured to move fins, wherein for the first heat transfer environment the fins are in a low heat transfer position and wherein for the second heat transfer environment the fins are in a high heat transfer position. An exemplary SMA moves fins that are positioned toward a housing or a heat sink of the electrical power device for the first heat transfer environment, and positioned away from the housing or the heat sink of the electrical device for the second heat transfer device.

Another exemplary SMA is operably coupled to a coolant valve, wherein the first heat transfer environment includes the SMA positioning the coolant valve into a closed position, and wherein the second heat transfer environment includes the SMA positioning the coolant valve into an open position. Yet another exemplary SMA includes a coolant valve including the SMA as a portion of the valve, and wherein the first heat transfer environment includes the SMA in a low flow position of the coolant valve and the second heat transfer environment includes the SMA in a high flow position of the coolant valve. The low flow position may be a closed position of the coolant valve.

Yet another exemplary embodiment includes the electrical power device as a battery pack including a number of cells having space therebetween, where the SMA is engageably coupled to the cells to change the space therebetween. In the low temperature position of the SMA, the first heat transfer environment includes the cells having low heat transfer spacing, and in a high temperature position of the SMA, the second heat transfer environment includes the cells having a high heat transfer spacing.

Another exemplary embodiment is a system including a vehicle having a hybrid power train, where the hybrid power train includes a battery pack having a number of cells. The system further includes a heat transfer adjustment device having a shape memory alloy (SMA). The SMA in a low temperature position provides a first heat transfer environment thermally coupled to the battery pack, and in a high temperature position provides a second heat transfer environment thermally coupled to the battery pack. The first heat transfer environment provides a first heat transfer amount with the battery pack and the second heat transfer environment provides a second heat transfer amount with the battery pack. The second heat transfer amount is greater than the first heat transfer amount.

An exemplary system further includes the SMA structured to move a number of vents to a compartment housing the battery pack. The first heat transfer environment includes the vents in a low flow rate position and the second heat transfer environment includes the vents in a high flow rate position. The low flow rate position may include the vents being closed, with the high flow rate position including the vents being open.

Another exemplary system further includes the SMA structured to move a number of fins thermally coupled to the battery pack. The first heat transfer environment includes the fins in a low heat transfer position and the second heat transfer environment includes the fins in a high heat transfer position. The low heat transfer position may be lowered or positioned close to the battery pack, and the high heat transfer position may be raised or positioned away from the battery pack. Alternatively, the low heat transfer position may be raised and the high heat transfer position may be lowered. In certain embodiments, the fins are thermally coupled to the battery pack through a heat sink device in thermal contact with the battery pack.

Another exemplary system includes the SMA operably coupled to a coolant valve, where the coolant valve controls a flow of a coolant. The flowing coolant is in thermal contact with the battery pack. The first heat transfer environment includes the coolant valve in a closed or low-flow position, and the second heat transfer environment includes the coolant valve in an open or high flow position.

Another exemplary system includes the SMA as a portion of a coolant valve, where the coolant valve controls a flow of a coolant. The flowing coolant is in thermal contact with the battery pack. The first heat transfer environment includes the SMA in a closed or low-flow position within the coolant valve, and the second heat transfer environment includes the SMA in an open or high-flow position within the coolant valve.

Another exemplary system includes the cells of the battery pack having a spacing between the cells. The SMA is engageably coupled to the cells to adjust the spacing between the cells. The first heat transfer environment includes the cells having a low heat transfer spacing when the SMA is in a low temperature position, and the second heat transfer environment includes the cells having a high heat transfer spacing when the SMA is in a high temperature position.

Yet another exemplary embodiment is a system including a vehicle having a hybrid power train, where the hybrid power train includes an electrical power device. The system further includes a means for selecting a heat transfer environment of the electrical power device between a first heat transfer environment and a second heat transfer environment. The first heat transfer environment provides a first heat transfer amount with the electrical power device and the second heat transfer environment provides a second heat transfer amount with the electrical power device. The second heat transfer amount is greater than the first heat transfer amount.

An exemplary means for selecting the heat transfer environment of the electrical power device does not use electrical power to perform the selection. The electrical power device may include a battery pack.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus, comprising:
a hybrid power train comprising an electrical power device;
a heat transfer adjustment device comprising a shape memory alloy (SMA), wherein the SMA in a low temperature position provides a first heat transfer environment thermally coupled to the electrical power device and in a high temperature position provides a second heat transfer environment thermally coupled to the electrical power device.

2. The apparatus of claim 1, wherein the SMA is structured to move a plurality of vents, and wherein the first heat transfer environment comprises the vents in a low flow rate position and wherein the second heat transfer environment comprises the vents in a high flow rate position.

3. The apparatus of claim 2, wherein the low flow rate position comprises the vents being closed, and wherein the high flow rate position comprises the vents being open.

4. The apparatus of claim 1, wherein the SMA is structured to move a plurality of fins, and wherein the first heat transfer environment comprises the fins in a low heat transfer position and wherein the second heat transfer environment comprises the fins in a high heat transfer position.

5. The apparatus of claim 1, wherein the SMA is structured to move a plurality of fins, and wherein the first heat transfer environment comprises the fins positioned toward one of a housing and a heat sink of the electrical power device, and wherein the second heat transfer environment comprises the fins positioned away from the one of the housing and the heat sink of the electrical power device.

6. The apparatus of claim 1, wherein the SMA is operably coupled to a coolant valve, wherein the first heat transfer environment comprises the coolant valve in a closed position and wherein the second heat transfer environment comprises the coolant valve in an open position.

7. The apparatus of claim 1, wherein the SMA comprises a portion of a coolant valve, wherein the first heat transfer environment comprises the SMA in a low flow position of the coolant valve and wherein the second heat transfer environment comprises the SMA in a high flow position of the coolant valve.

8. The apparatus of claim 7, wherein the low flow position of the coolant valve comprises the coolant valve in a closed position.

9. The apparatus of claim 1, wherein the electrical power device comprises a battery pack having a plurality of cells, the plurality of cells having a spacing therebetween, wherein the SMA is engageably coupled to the plurality of cells to change the spacing therebetween, wherein the first heat transfer environment comprises the cells having low heat transfer spacing and wherein the second heat transfer environment comprises the cells having a high heat transfer spacing.

10. A system, comprising:
a vehicle including a hybrid power train, the hybrid power train comprising a battery pack having a plurality of cells;
a heat transfer adjustment device comprising a shape memory alloy (SMA), wherein the SMA in a low temperature position provides a first heat transfer environment thermally coupled to the battery pack and in a high temperature position provides a second heat transfer environment thermally coupled to the battery pack; and
wherein the first heat transfer environment is structured to provide a first heat transfer amount with the battery pack and wherein the second heat transfer environment is structured to provide a second heat transfer amount with the battery pack, wherein the second heat transfer amount is greater than the first heat transfer amount.

11. The system of claim 10, wherein the SMA is structured to move a plurality of vents to a compartment housing the battery pack, wherein the first heat transfer environment comprises the vents in a low flow rate position and wherein the second heat transfer environment comprises the vents in a high flow rate position.

12. The system of claim 11, wherein the low flow rate position comprises the vents being closed, and wherein the high flow rate position comprises the vents being open.

13. The system of claim 10, wherein the SMA is structured to move a plurality of fins thermally coupled to the battery pack, and wherein the first heat transfer environment comprises the fins in a low heat transfer position and wherein the second heat transfer environment comprises the fins in a high heat transfer position.

14. The system of claim 10, wherein the SMA is operably coupled to a coolant valve, the coolant valve controlling a flow of a coolant, wherein the flowing coolant is in thermal contact with the battery pack, wherein the first heat transfer environment comprises the coolant valve in a closed position and wherein the second heat transfer environment comprises the coolant valve in an open position.

15. The system of claim 10, wherein the SMA comprises a portion of a coolant valve, the coolant valve controlling a flow of a coolant, wherein the flowing coolant is in thermal contact with the battery pack, wherein the first heat transfer environment comprises the SMA in a low flow position of the coolant valve and wherein the second heat transfer environment comprises the SMA in a high flow position of the coolant valve.

16. The system of claim 15, wherein the low flow position of the coolant valve comprises the coolant valve in a closed position.

17. The system of claim 10, wherein the plurality of cells include a spacing therebetween, wherein the SMA is engageably coupled to the plurality of cells to change the spacing therebetween, wherein the first heat transfer environment comprises the cells having low heat transfer spacing and wherein the second heat transfer environment comprises the cells having a high heat transfer spacing.

18. A system, comprising:
a vehicle including a hybrid power train, the hybrid power train comprising an electrical power device;
a means for selecting a heat transfer environment of the electrical power device between a first heat transfer environment and a second heat transfer environment; and
wherein the first heat transfer environment is structured to provide a first heat transfer amount with the electrical power device and wherein the second heat transfer environment is structured to provide a second heat transfer amount with the electrical power device, wherein the second heat transfer amount is greater than the first heat transfer amount.

19. The system of claim 18, wherein the means for selecting the heat transfer environment of the electrical power device does not use electrical power.

20. The system of claim 19, wherein the electrical power device comprises a battery pack.
